(19) United States
(12) Patent Application Publication
(10) Pub. No.: US 2023/0026719 A1
(43) Pub. Date: Jan. 26, 2023

(54) TARGETED GRADIENT DESCENT FOR CONVOLUTIONAL NEURAL NETWORKS FINE-TUNING AND ONLINE-LEARNING

(71) Applicant: CANON MEDICAL SYSTEMS CORPORATION, Otawara-shi (JP)

(72) Inventors: Chung CHAN, Vernon Hills, IL (US); Junyu CHEN, Vernon Hills, IL (US); Evren ASMA, Vernon Hills, IL (US); Jeffrey KOLTHAMMER, Vernon Hills, IL (US)

(73) Assignee: CANON MEDICAL SYSTEMS CORPORATION, Otawara-shi (JP)

(21) Appl. No.: 17/469,144

(22) Filed: Sep. 8, 2021

Related U.S. Application Data
(60) Provisional application No. 63/220,147, filed on Jul. 9, 2021.
(60) Provisional application No. 63/225,115, filed on Jul. 23, 2021.

(51) Int. Cl. G06N 3/08; G06N 3/04; G06V 10/771; G06V 10/82

(52) U.S. Cl. CPC G06N 3/082; G06N 3/0481; G06V 10/771; G06V 10/82

(57) ABSTRACT

A neural network is initially trained to remove errors and is later fine tuned to remove less-effective portions (e.g., kernels) from the initially trained network and replace them with further trained portions (e.g., kernels) trained with data after the initial training.

### CROSS REFERENCE TO CO-PENDING APPLICATIONS

The present application claims priority under 35 U.S.C. § 119(e) to U.S. Provisional Patent Application No. 63/220,147, filed Jul. 9, 2021, and U.S. Provisional Application No. 63/225,115, filed on Jul. 23, 2021, the contents of which are incorporated herein by reference.

### BACKGROUND

In a number of medical imaging modalities (including, but not limited to, computed tomography (CT) and positron emission tomography (PET)), neural networks can be trained to remove errors (e.g., noise and artifacts) that exist in images to produce improved images that can be analyzed by medical professionals and/or computer-based system, and in one embodiment, a neural network is initially trained to remove errors and is later fine tuned to remove less-effective portions (e.g., kernels) from the initially trained network and replace them with further trained portions (e.g., kernels) trained with data after the initial training.

### BACKGROUND

Convolutional Neural Networks (ConvNets) are usually trained and tested on datasets where images were sampled from the same distribution. However, ConvNet does not generalize well and its performance may degrade significantly and it may generate artifacts when applied to out-of-distribution (unseen) samples. For example, see (1) Chan, C., Yang, L., Asma, E.: Estimating ensemble bias using bayesian convolutional neural network, 2020 IEEE Nuclear Science Symposium and Medical Imaging Conference (NSS/MIC). IEEE (2020), and (2) Laves, M. H. et al., Uncertainty estimation in medical image denoising with bayesian deep image prior, Uncertainty for Safe Utilization of Machine Learning in Medical Imaging, and Graphs in Biomedical Image Analysis, pp. 81-96. Springer (2020).

In medical imaging, generating high quality labels is often tedious, time-consuming, and expensive. In most scenarios, it is nearly impossible to collect every possible representative dataset a priori. The new data may only become available after the ConvNet is deployed. It is thus imperative to develop fine-tuning methods that can generalize well to various image distributions with minimum need for additional training data and training time, while retaining the network's performance on the prior task after fine-tuning.

For example, each clinical site might prefer different imaging protocols for their own patient demographics, while the pre-trained network is usually trained from a cohort of training datasets collected from a few specific sites that covers a narrow range of patient demographics & imaging protocols. Ultimately, it is desirable to develop an “always learning” algorithm that can quickly fine-tune and adapt a pretrained ConvNet to each testing dataset specifically to avoid generating artifacts and for optimal performance.

It is known to use fine-tuning to avoid training a ConvNet from scratch. During fine-tuning, a pre-trained network, usually trained using a large number of datasets from a different task/application, its parameters are updated by a smaller dataset of a new task. See (1) Gong, K., Guan, J., Liu, C. C., Qi, J.: Pet image denoising using a deep neural network through fine tuning. IEEE Transactions on Radiation and Plasma Medical Sciences 3(2), 153-161 (2018) and (2) Amiri, M., Brooks, R., Rivaz, H.: Fine tuning u-net for ultrasound image segmentation: which layers? In: Domain Adaptation and Representation Transfer and Medical Image Learning with Less Labels and Imperfect Data, pp. 235-242. Springer (2019).

The network kernel updating scheme can be limited to the a few specific layers but this method does not guarantee retaining the useful knowledge acquired from previous training. When a new task is introduced, new adaptions overwrite the knowledge that the neural network had previously acquired, leading to a severe performance degradation on previous tasks. As a result, this approach may not be suitable for the applications in which both tasks are of interest during testing.

Another approach is using joint training. See Caruana, R.: Multitask learning. Machine learning, 28(1), 41-75 (1997) and Wu, C., Herranz, L., Liu, X., van de Weijer, J., Raducanu, B., et al.: Memory replay gans: Learning to generate new categories without forgetting. In: Advances in Neural Information Processing Systems, pp. 5962-5972 (2018). Such joint training typically requires revisiting data from previous tasks during learning the new task.

Yet another approach is to use incremental learning. See, e.g., (1) Francisco M. Castro, Manuel J. Marin-Jiménez, Nicolas Guil, Cordelia Schmid, Karteek Alahari, End-to-end incremental learning, Proceedings of the European conference on computer vision (ECCV), pp. 233-248 (2018), (2) Rusu, A. A., Rabinowitz, N.C., Desjardins, G., Soyer, H., Kirkpatrick, J., Kavukcuoglu, K., Pascanu, R., Hadsell, R.: Progressive neural networks, arXiv preprint arXiv:1606.04671 (2016), and (3) Tasar, O., Tarabalka, Y., Alliez, P.: Incremental learning for semantic segmentation of largescale remote sensing data. IEEE Journal of Selected Topics in Applied Earth Observations and Remote Sensing 12(9), 3524-3537 (2019). Such approaches try to adapt a pre-trained network to new tasks while preserving the network's original capabilities. As noted in Progressive neural networks, such joint training may require modifying the network's architecture. However, these methods typically require some level of revisiting training data from previous tasks and become less feasible if the old data is unavailable.

### SUMMARY

In light of the background discussed above, a number of methods of fine tuning an existing network are described herein including implementations in circuitry and on programmed processing circuitry. Such implementation may (1) extend a pre-trained network (e.g., a convolutional neural network) to a new task without revisiting data from the previous task while preserving the knowledge acquired from previous training and/or (2) enable online learning that can adapt a pre-trained network to each testing dataset to avoid generating artefacts on unseen features.

In one such implementation, the subsequent training process (i.e., the training process after the initial training process), utilizes a Targeted Gradient Descent (TGD) fine-tuning in which less useful kernels (e.g., kernels that are “redundant” or “meaningless”) in the pre-trained network are re-trained using the data from a new task, while “protecting” the “useful” kernels (described as “protected” kernels) from being updated with data from a new task. After fine-tuning, the updated kernels will work collaboratively with the protected kernels to improve the performance of the network on the new data while retaining its performance on the old task.

The Targeted Gradient Descent (TGD) fine-tuning described herein can be combined with Noise-2-Noise training as described in (1) Chan, C., Zhou, J., Yang, L., Qi, W., Asma, E.: Noise to noise ensemble learning for pet image denoising, 2019 IEEE Nuclear Science Symposium and Medical Imaging Conference (NSS/MIC). pp. 1-3. IEEE (2019) and (2) Lehtinen, J., Munkberg, J., Hasselgren, J., Laine, S., Karras, T., Aittala, M., Aila, T.: Noise2noise: Learning image restoration without clean data, ICML (2018). Together, the TGD and Noise-2-Noise learning enables “always learning” that can fine-tune a baseline network for each testing study individually to tackle out-of-distribution testing samples, and TGD can be also be applied in a sequential order to fine-tune a network multiple times without the need to revisit all the prior training data.

Although the discussion below relates to computed tomography (CT) imaging and positron emission tomography (PET) imaging, the techniques described herein can be extended to other medical imaging modalities as well. Thus, the techniques herein should be understood to extend beyond CT-based and PET-based imaging.

### BRIEF DESCRIPTION OF THE DRAWINGS

FIG. 1 is a block diagram of a CT scanner for obtaining images to be processed according to the techniques described herein as initial training images, fine tuning training images, and images to be corrected using an initially-trained network and/or a fine-tuned network.

FIG. 2 shows a perspective view of a positron-emission tomography (PET) scanner, according to one implementation.

FIG. 3 shows a schematic view of the PET scanner, according to one implementation.

FIG. 4 is a flowchart of a general process for fine-tuning an existing neural network to be able to perform additional capabilities.

FIG. 5A illustrates a fine-tuning process in which Task A image properties have changed due to the updates in the image formation chain, and the network needs to be fine-tuned for new Task A images.

FIG. 5B illustrates a fine-tuning process in which only a small amount of Task B training datasets can be collected and the previously trained network trained for Task A images needs to be fine-tuned so that the resulting network is trained for both Task A images (e.g., body images) and Task B images (e.g., brain images).

FIG. 5C illustrates an online learning process in which a new test image similar to Task A images (e.g., body images) but collected after the network is deployed is used as part of an updating of the network because the new test image contains features not included in the training datasets and the initially trained network needs to be fine-tuned for this specific study.

FIG. 5D illustrates a sequential fine-tuning process in which a pretrained network trained on Task A images needs to be fine-tuned for both Task B and Task C images as well (without losing its known efficacy for processing Task A images).

FIG. 6A illustrates an exemplary neural network on which kernel-retraining is performed on two exemplary layers of the network (although retraining can be performed on any number of the kernels in any number of the networks).

FIG. 6B illustrates an expanded view of the two exemplary layers of the network of FIG. 6A on which kernel-retraining is performed.

FIG. 6C is a back-propagation formula for the weights that is adjusted to incorporate the binary mask (Mₙ) that determines which kernels to update.

FIG. 7 is an illustration of a sample denoising network architecture of FIG. 6A supplemented to include a pair of Targeted Gradient Descent (TGD) layers sandwiching the batch normalization layers in each of the hidden layers.

FIG. 8A is a first input image that was not part of the input images used to train a previously trained network and includes a simulated lesion to be processed as a Task B.

FIG. 8B is a resulting denoised image that was produced after being applied to the previously trained network where the previously trained network reduces the visibility of the simulated lesion as compared with the image of FIG. 8C.

FIG. 8C is a resulting denoised image which was produced by a re-trained version of the previously trained network that was fine-tuned with TGD processing on the Task B image.

FIG. 8D is a second image that was part of the input images used to train a previously trained network and includes an unseen feature.

FIG. 8E is a denoised image that was produced after being applied to the previously trained network where the previously trained network produces an artefact from the unseen feature.

FIG. 8F is a resulting denoised image which was produced by a re-trained version of the previously trained network where the re-trained version was fine-tuned with TGD-Noise2Noise processing.

FIG. 9A illustrates the metric values and mask values calculated for the input feature maps of layer i using the corresponding weights from the i-th convolutional layer assuming that the usefulness threshold φ is chosen as 0.3.

FIG. 9B illustrates the metric values and mask values calculated for the input feature maps of layer i using the corresponding weights from the i-th convolutional layer assuming that the usefulness threshold φ is chosen as 0.3 but the maximum number of masks that can be set to 1 are half of the metrics that satisfy the usefulness threshold φ where the matching indices are chosen at random a first time.

FIG. 9C illustrates the metric values and mask values calculated for the input feature maps of layer i using the corresponding weights from the i-th convolutional layer assuming that the usefulness threshold φ is chosen as 0.3 but the maximum number of masks that can be set to 1 are half of the metrics that satisfy the usefulness threshold φ where the matching indices are chosen at random a second time.

FIG. 10 is a comparison of an embodiment of the present invention and other methods on a FDG-PET patient study which had urinary catheters attached during the scan.

FIG. 11 is a set of comparison images using two different reconstruction techniques.

FIG. 12 is a set of comparison images obtained by varying a KSE threshold.

FIG. 13 is a set of comparison images between an embodiment of the present invention and other methods of denoising on two patient studies.

FIG. 14 is a set of comparison images between an embodiment of the present invention and other methods of denoising on two patient studies.

### DETAILED DESCRIPTION

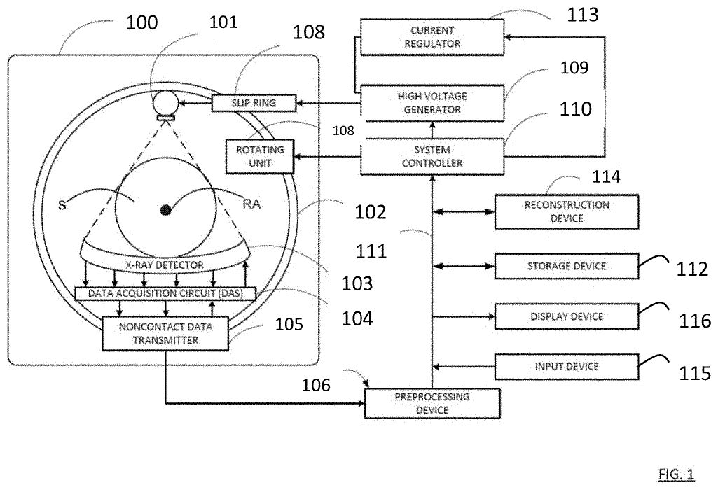

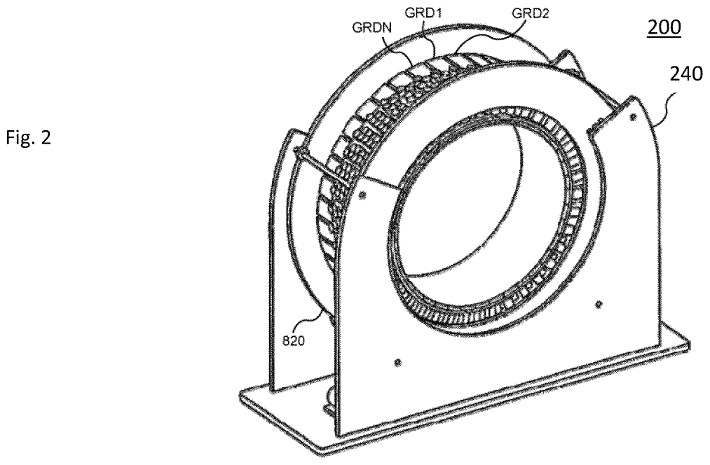

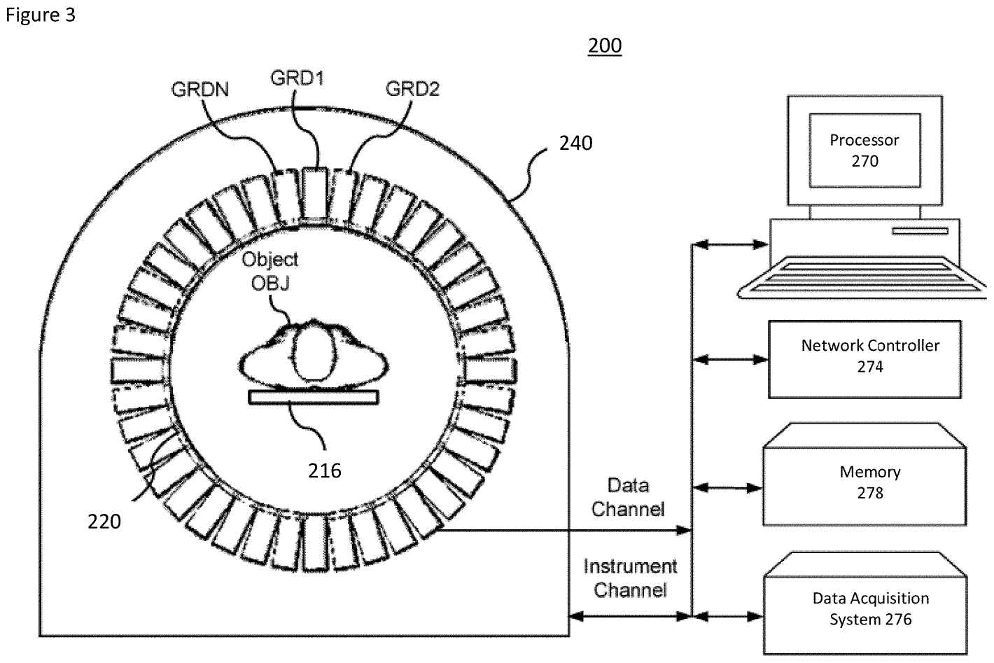

This disclosure is related to improving image quality by utilizing neural networks. In an exemplary embodiment illustrated in FIG. 1, the present disclosure relates to a CT scanner. In another exemplary embodiment illustrated in FIGS. 2 and 3, the present disclosure relates to a PET scanner. Of course, in other embodiments, any other system with other medical imaging modalities can be used.

As context for the neural network processing described herein later, FIG. 1 shows a schematic of an implementation of a CT scanner according to an embodiment of the disclosure. Referring to FIG. 1, a radiography gantry 100 is illustrated from a side view and further includes an X-ray tube 101, an annular frame 102, and a multi-row or two-dimensional-array-type X-ray detector 103. The X-ray tube 101 and X-ray detector 103 are diametrically mounted across an object OBJ on the annular frame 102, which is rotatably supported around a rotation axis RA (or an axis of rotation). A rotating unit 107 rotates the annular frame 102 at a high speed, such as 0.4 sec/rotation, while the subject S is being moved along the axis RA into or out of the illustrated page.

X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. The rotate/rotate type will be used as an example for purposes of clarity.

The CT apparatus further includes a high voltage generator 109 that generates a tube voltage applied to the X-ray tube 101 through a slip ring 108 so that the X-ray tube 101 generates X-rays (e.g. cone beam X-ray). The X-rays are emitted towards the subject S, whose cross sectional area is represented by a circle. For example, the X-ray tube 101 having an average X-ray energy during a first scan that is less than an average X-ray energy during a second scan. Thus, two or more scans can be obtained corresponding to different X-ray energies. The X-ray detector 103 is located at an opposite side from the X-ray tube 101 across the object OBJ for detecting the emitted X-rays that have transmitted through the object OBJ. The X-ray detector 103 further includes individual detector elements or units.

The CT apparatus further includes other devices for processing the detected signals from X-ray detector 103. A data acquisition circuit or a Data Acquisition System (DAS) 104 converts a signal output from the X-ray detector 103 for each channel into a voltage signal, amplifies the signal, and further converts the signal into a digital signal. The X-ray detector 103 and the DAS 104 are configured to handle a predetermined total number of projections per rotation (TPPR).

The above-described data is sent to a preprocessing device 106, which is housed in a console outside the radiography gantry 100 through a non-contact data transmitter 105. The preprocessing device 106 performs certain corrections, such as sensitivity correction on the raw data. A memory 112 stores the resultant data, which is also called projection data at a stage immediately before reconstruction processing. The memory 112 is connected to a system controller 110 through a data/control bus 111, together with a reconstruction device 114, input device 115, and display 116. The system controller 110 controls a current regulator 113 that limits the current to a level sufficient for driving the CT system.

The detectors are rotated and/or fixed with respect to the patient among various generations of the CT scanner systems. In one implementation, the above-described CT system can be an example of a combined third-generation geometry and fourth-generation geometry system. In the third-generation system, the X-ray tube 101 and the X-ray detector 103 are diametrically mounted on the annular frame 102 and are rotated around the object OBJ as the annular frame 102 is rotated about the rotation axis RA. In the fourth-generation geometry system, the detectors are fixedly placed around the patient and an X-ray tube rotates around the patient. In an alternative embodiment, the radiography gantry 100 has multiple detectors arranged on the annular frame 102, which is supported by a C-arm and a stand.

The memory 112 can store the measurement value representative of the irradiance of the X-rays at the X-ray detector unit 103. Further, the memory 112 can store a dedicated program for executing, for example, various steps of the methods and workflows discussed herein.

The reconstruction device 114 can execute various steps of the methods/workflows discussed herein. Further, reconstruction device 114 can execute pre-reconstruction processing image processing such as volume rendering processing and image difference processing as needed.

The pre-reconstruction processing of the projection data performed by the preprocessing device 106 can include correcting for detector calibrations, detector nonlinearities, and polar effects, for example.

Post-reconstruction processing performed by the reconstruction device 114 can include filtering and smoothing the image, volume rendering processing, and image difference processing as needed. The image reconstruction process can implement several of the steps of methods discussed herein in addition to various CT image reconstruction methods. The reconstruction device 114 can use the memory to store, e.g., projection data, reconstructed images, calibration data and parameters, and computer programs.

The reconstruction device 114 can include a CPU (processing circuitry) that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory 112 can be non-volatile, such as ROM, EPROM, EEPROM or FLASH memory. The memory 112 can also be volatile, such as static or dynamic RAM, and a processor, such as a microcontroller or microprocessor, can be provided to manage the electronic memory as well as the interaction between the FPGA or CPLD and the memory.

Alternatively, the CPU in the reconstruction device 114 can execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OS and other operating systems known to those skilled in the art. Further, CPU can be implemented as multiple processors cooperatively working in parallel to perform the instructions.

In one implementation, the reconstructed images can be displayed on a display 116. The display 116 can be an LCD display, CRT display, plasma display, OLED, LED or any other display known in the art.

The memory 112 can be a hard disk drive, CD-ROM drive, DVD drive, FLASH drive, RAM, ROM or any other electronic storage known in the art.

As additional context for the neural network processing described herein later, FIGS. 2 and 3 show a PET scanner 200 including a number of GRDs (e.g., GRD1, GRD2, through GRDN) that are each configured as rectangular detector modules. According to one implementation, the detector ring includes 40 GRDs. In another implementation, there are 48 GRDs, and the higher number of GRDs is used to create a larger bore size for the PET scanner 200.

Each GRD can include a two-dimensional array of individual detector crystals, which absorb gamma radiation and emit scintillation photons. The scintillation photons can be detected by a two-dimensional array of photomultiplier tubes (PMTs) that are also arranged in the GRD. A light guide can be disposed between the array of detector crystals and the PMTs. Further, each GRD can include a number of PMTs of various sizes, each of which is arranged to receive scintillation photons from a plurality of detector crystals. Each PMT can produce an analog signal that indicates when scintillation events occur, and an energy of the gamma ray producing the detection event. Moreover, the photons emitted from one detector crystal can be detected by more than one PMT, and, based on the analog signal produced at each PMT, the detector crystal corresponding to the detection event can be determined using Anger logic and crystal decoding, for example.

FIG. 3 shows a schematic view of a PET scanner system having gamma-ray (gamma-ray) photon counting detectors (GRDs) arranged to detect gamma-rays emitted from an object OBJ. The GRDs can measure the timing, position, and energy corresponding to each gamma-ray detection. In one implementation, the gamma-ray detectors are arranged in a ring, as shown in FIGS. 2 and 3. The detector crystals can be scintillator crystals, which have individual scintillator elements arranged in a two-dimensional array and the scintillator elements can be any known scintillating material. The PMTs can be arranged such that light from each scintillator element is detected by multiple PMTs to enable Anger arithmetic and crystal decoding of scintillation event.

FIG. 3 shows an example of the arrangement of the PET scanner 200, in which the object OBJ to be imaged rests on a table 816 and the GRD modules GRD1 through GRDN are arranged circumferentially around the object OBJ and the table 216. The GRDs can be fixedly connected to a circular component 220 that is fixedly connected to the gantry 240. The gantry 240 houses many parts of the PET imager. The gantry 240 of the PET imager also includes an open aperture through which the object OBJ and the table 216 can pass, and gamma-rays emitted in opposite directions from the object OBJ due to an annihilation event can be detected by the GRDs and timing and energy information can be used to determine coincidences for gamma-ray pairs.

In FIG. 3, circuitry and hardware is also shown for acquiring, storing, processing, and distributing gamma-ray detection data. The circuitry and hardware include: a processor 270, a network controller 274, a memory 278, and a data acquisition system (DAS) 276. The PET imager also includes a data channel that routes detection measurement results from the GRDs to the DAS 276, a processor 270, a memory 278, and a network controller 274. The data acquisition system 276 can control the acquisition, digitization, and routing of the detection data from the detectors. In one implementation, the DAS 276 controls the movement of the bed 216. The processor 270 performs functions including initial training, fine-tuning, and processing of images using the initially-trained and/or fine-tuned networks as discussed herein.

The processor 270 can include a CPU that can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog, or any other hardware description language and the code may be stored in an electronic memory directly within the FPGA or CPLD, or as a separate electronic memory. Further, the memory may be non-volatile, such as ROM, EPROM, EEPROM or FLASH memory. The memory can also be volatile, such as static or dynamic RAM, and a processor, such as a microcontroller or microprocessor, may be provided to manage the electronic memory as well as the interaction between the FPGA or CPLD and the memory.

Alternatively, the CPU in the processor 270 can execute a computer program including a set of computer-readable instructions that perform method 400 described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as MICROSOFT WINDOWS, UNIX, SOLARIS, LINUX, APPLE MAC OS and other operating systems known to those skilled in the art. Further, CPU can be implemented as multiple processors cooperatively working in parallel to perform the instructions.

In one implementation, the reconstructed image can be displayed on a display. The display can be an LCD display, CRT display, plasma display, OLED, LED or any other display known in the art.

The memory 278 can be a hard disk drive, CD-ROM drive, DVD drive, FLASH drive, RAM, ROM or any other electronic storage known in the art.

The network controller 274, such as an Intel Ethernet PRO network interface card from Intel Corporation of America, can interface between the various parts of the PET imager. Additionally, the network controller 274 can also interface with an external network. As can be appreciated, the external network can be a public network, such as the Internet, or a private network such as an LAN or WAN network, or any combination thereof and can also include PSTN or ISDN sub-networks. The external network can also be wired, such as an Ethernet network, or can be wireless such as a cellular network including EDGE, 3G and 4G wireless cellular systems. The wireless network can also be WiFi, Bluetooth, or any other wireless form of communication that is known.

The method and system described herein can be implemented in a number of technologies but generally relate to processing circuitry for performing the techniques described herein. In one embodiment, the processing circuitry is implemented as one of or as a combination of: an application specific integrated circuit (ASIC), a field programmable gate array (FPGA), a generic array of logic (GAL), a programmable array of logic (PAL), circuitry for allowing one-time programmability of logic gates (e.g., using fuses) or reprogrammable logic gates. Furthermore, the processing circuitry can include a computer processor and having embedded and/or external non-volatile computer readable memory (e.g., RAM, SRAM, FRAM, PROM, EPROM, and/or EEPROM) that stores computer instructions (binary executable instructions and/or interpreted computer instructions) for controlling the computer processor to perform the processes described herein. The computer processor circuitry may implement a single processor or multiprocessors, each supporting a single thread or multiple threads and each having a single core or multiple cores. In an embodiment in which neural networks are used, the processing circuitry used to train the artificial neural network need not be the same as the processing circuitry used to implement the trained artificial neural network that performs the denoising described herein. For example, processor circuitry and memory may be used to produce a trained artificial neural network (e.g., as defined by its interconnections and weights), and an FPGA may be used to implement the trained artificial neural network. Moreover, the training and use of a trained artificial neural network may use a serial implementation or a parallel implementation for increased performance (e.g., by implementing the trained neural network on a parallel processor architecture such as a graphics processor architecture).

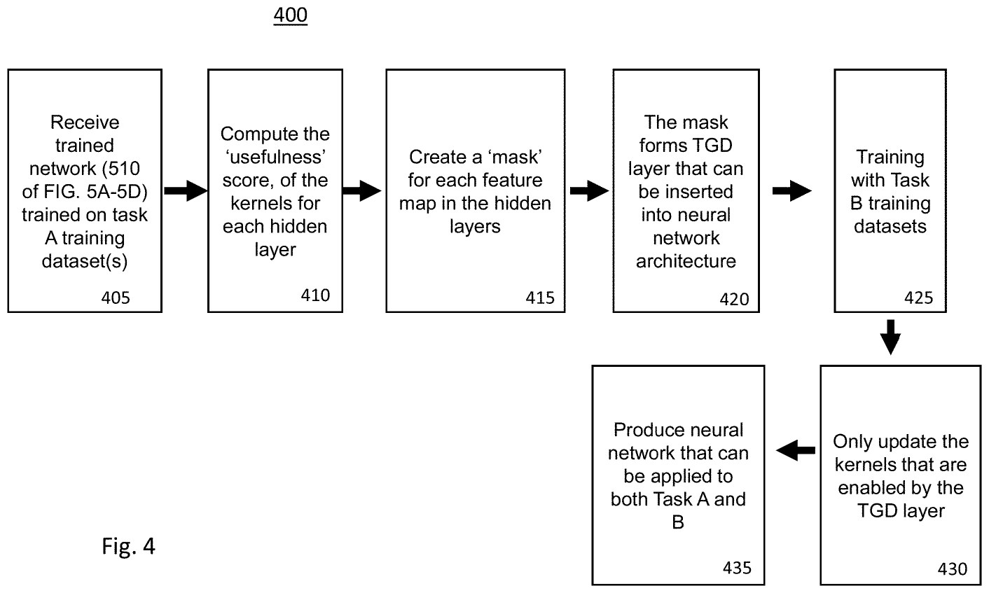

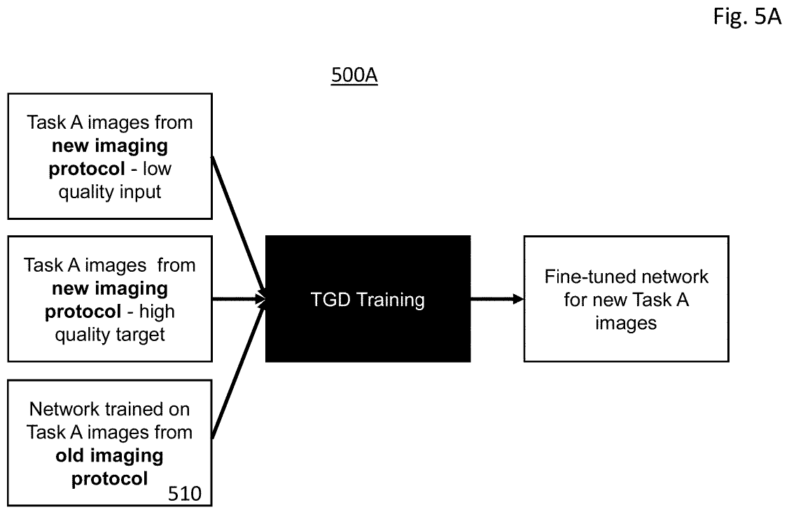

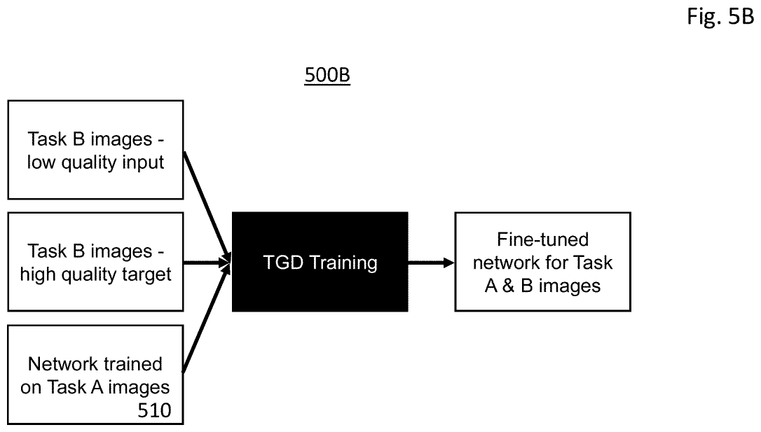

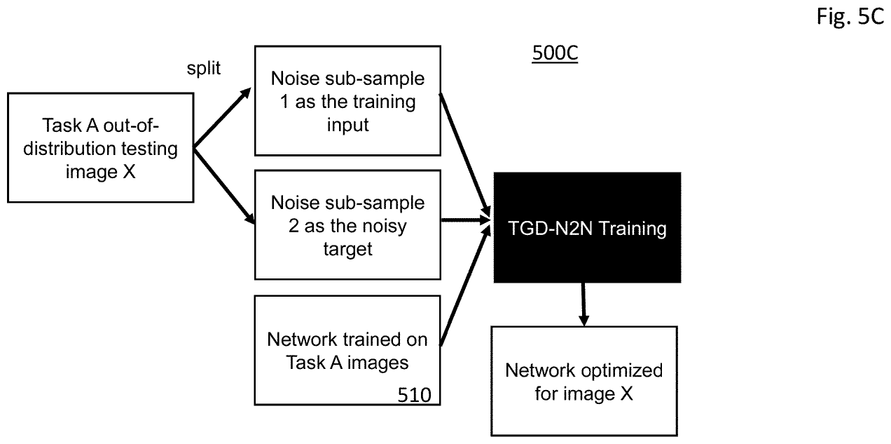

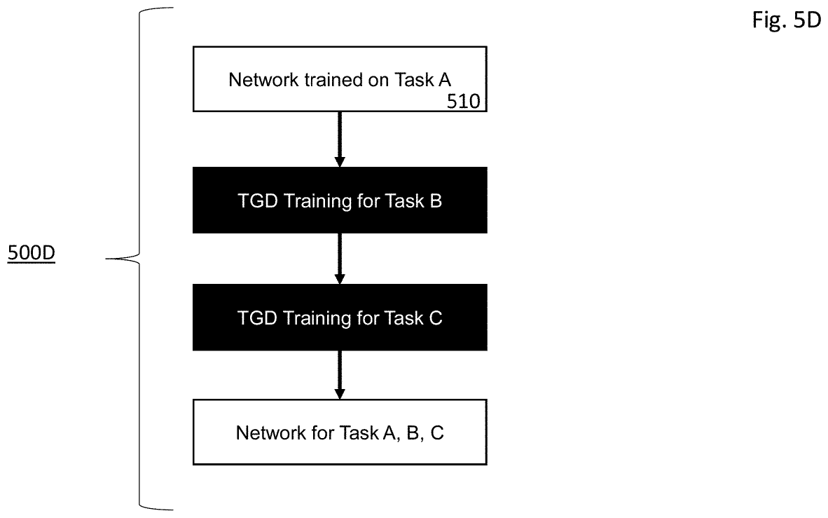

FIG. 4 is a flowchart of a general process 400 for fine-tuning an existing neural network (e.g., a convolutional neural network) to be able to perform additional capabilities. In general, the process 400 begins with step 405 in which an exemplary trained network (510 shown in FIGS. 5A-5D) is received that has been trained for Task A (e.g., denoising of images) based on at least one initial training dataset. In step 410, the system computes a ‘usefulness’ score according to at least one metric for each of the kernels for each hidden layer. Exemplary metrics include, but are not limited to, Magnitude-based kernel ranking and Kernel Sparsity and Entropy (KSE). Details of one implementation of Magnitude-based kernel ranking can be found in Gomez, A., Zhang, I., Swersky K., Gal Y., Hinton G., Targeted Dropout, NIPS 2018 Workshop, and/or Gomez, A. Zhang, I., Kamalakara, S. R., Madaan, D., Swersky, K. Gal, Y. and Hinton, G., Learning Sparse Networks Using Targeted Dropout, arXiv:1905.13678 (2109) the contents of which are incorporated herein by reference. Details of one implementation of Magnitude-based kernel ranking can be found in Li, Y., Lin, S., Zhang, B., Liu, J., Doermann, D., Wu, Y., Huang, F., Ji, R.: Exploiting kernel sparsity and entropy for interpretable cnn compression, Proceedings of the IEEE Conference on Computer Vision and Pattern Recognition. pp. 2800-2809 (2019), the contents of which are incorporated herein by reference. Additional metrics for identifying the “usefulness” of a kernel can be calculated based on: (1) minimum weight, (2) activations, (3) mutual information, and/or (4) Taylor expansion. Those metrics also may be referred to herein as “pruning metrics” as they signify which portions of the network can be pruned without significant loss of functionality in the network.

The metric can be based on any identifiable scale, but in one embodiment the metric is a normalized metric which is compared to a normalized threshold. For example, the most useful kernel possible would be assigned a score of 1.0 (or 100%) and the most useless kernel would be assigned a score of 0.0 (or 0%). However, it is possible to use the reverse scale where the least useful kernel possible would be assigned a score of 1.0 (or 100%) and the most useful kernel would be assigned a score of 0.0 (or 0%). Using such a reverse scale, the relative comparison functions (i.e., less than and greater than or equal) described herein would be reversed. Without a loss of generalization, the following description will be made with reference to the most useful kernel possible being assigned a score of 1.0 (or 100%) and the most useless kernel being assigned a score of 0.0 (or 0%).

In step 415, based on the calculated usefulness score for each kernel, the system determines a mask value (e.g., mask=0 for kernels with useful feature maps and mask=1 for kernels with useless feature maps) for the respective kernels to signify whether the kernel is a preserve target kernel (i.e., a useful kernel) or an update target kernel (i.e., a relatively useless kernel). That is, in an exemplary re-training process, a normalized threshold (φ) is set at 0.3 such that kernels having a normalized metric of 0.3 or higher would be assigned mask=0 and considered preserve target kernels (i.e., kernels that were not to be modified during retraining), and kernels having a normalized metric of less than 0.3 would be assigned mask=1 and considered update target kernels (i.e., kernels that are to be modified during retraining). In step 420, the mask forms a TGD layer that can be inserted into a convolutional neural network architecture. The network being retrained (including the TGD layer with the masks set in step 415) is then trained in step 425 with Task B training datasets, but, as shown in step 430, only the kernels that are enabled by the TGD layer (e.g., because they have mask values equal to 1) are updated. As a result, a new network is produced that can be applied to both Task A and Task B.

As shown in FIGS. 5A-5D, there are at least four scenarios in which the retraining described herein with respect to FIG. 4 can be performed. All of the scenarios have in common an initial network 510 that has been trained for Task A images to perform a particular function (e.g., denoise Task A-style images and/or identify the presence or absence of a particular feature (such as a lesion) within the Task A-style images). In the first scenario, as illustrated in FIG. 5A, an existing network 510 trained on Task A-style images is to be fine-tuned. A fine-tuning process 500A is used to account for the fact that Task A image properties have changed due to the updates in the image formation chain, and the network needs to be fine-tuned for new Task A images.

FIG. 5B illustrates a second fine-tuning process 500B in which only a small amount of Task B training datasets can be collected and the previously trained network trained 510 for Task A images needs to be fine-tuned so that the resulting network is trained for both Task A images (e.g., body images) and Task B images (e.g., brain images).

FIG. 5C illustrates an online learning process 500C in which a new test image similar to Task A images (e.g., body images) but collected after the network is deployed is used as part of an updating of the network 510 because the new test image contains features not included in the training datasets and the initially trained network needs to be fine-tuned for this specific study.

FIG. 5D illustrates a sequential fine-tuning process 500D in which a pretrained network 510 trained on Task A images needs to be fine-tuned for both Task B and Task C images as well (without losing its known efficacy for processing Task A images).

In each of the processes 500A-500D, the system is designed to maintain the effectiveness of the original network 510 while allowing additional processing capabilities to be added. To do so, those processes each perform at least one Targeted Gradient Descent (TGD) processing in which specific kernels that generate redundant feature maps are retrained while “useful” kernels are kept “frozen” or “protected” during fine-tuning.

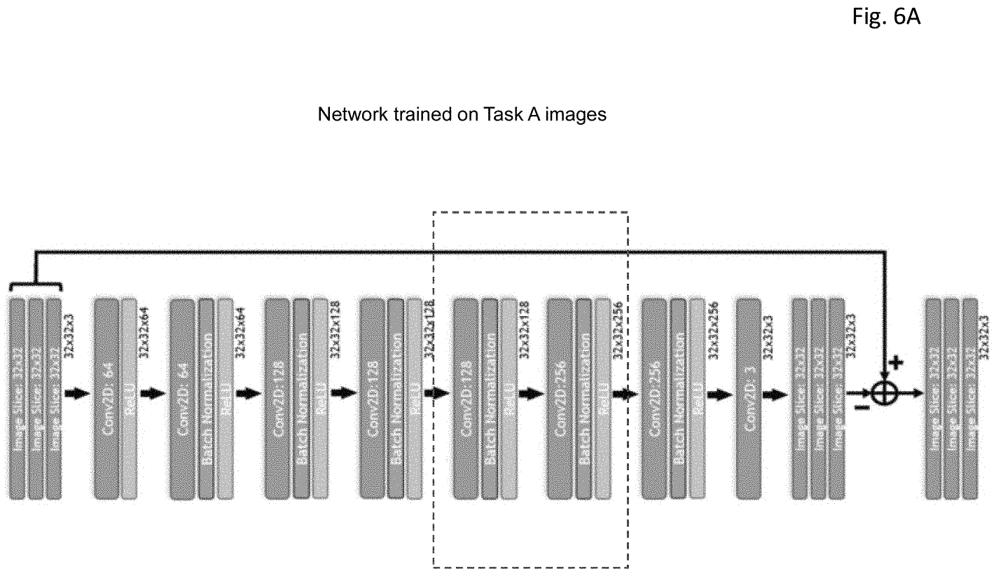

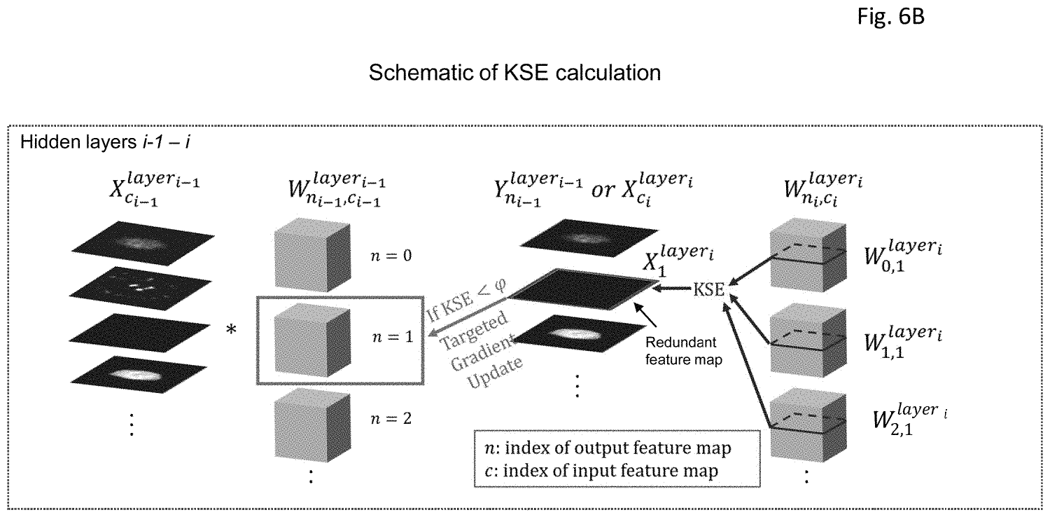

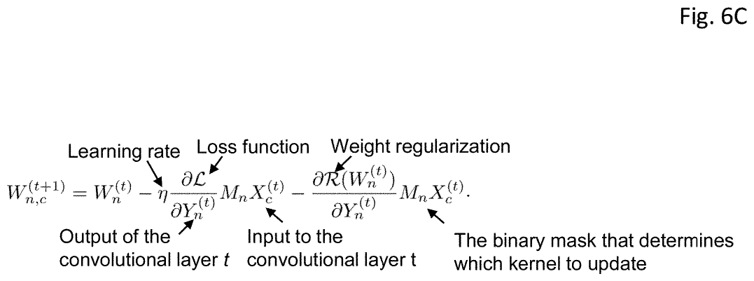

FIG. 6A illustrates an exemplary neural network on which kernel-retraining is performed on two exemplary hidden layers of the network (although retraining can be performed on any number of the kernels in any number of the networks). FIG. 6B illustrates an expanded view of the two exemplary hidden layers of the network of FIG. 6A on which kernel-retraining is performed. FIG. 6B illustrates identifying kernels that generate redundant feature maps (or feature maps that are less useful than a specified threshold) according to a pruning metric.

In a KSE-based approach where KSE is used as the metric described herein, kernel weights (generally referred to as W) in layer i (i.e.,W_{n,c}^{layeri}) were used to calculate KSE scores for the input feature maps in layer i (i.e., X_{c}^{layeri}) then the kernels in layer i (e.g. the boxed weights: W_{n,ci-1}^{layeri-1}) that generated the input feature maps in layer i (i.e.) were identified and would be retrained as being part of an update target kernel. The KSE quantifies the sparsity and information richness in a kernel to evaluate a feature map's importance to the network. The KSE contains two parts: the kernel sparsity, s_{c}, and the kernel entropy, e_{c}, and they are briefly described here.

Kernel Sparsity:

A sparse input feature map, X, may result in a sparse kernel during training. This is because the sparse feature map may yield a small weight update on the kernel. The kernel sparsity for the c^{th} input feature map is defined as:

$${s}_{c} = {\sum }_{n = 1}^{N} \vert {W}_{n , c} \vert ,$$

Kernel Entropy:

Kernel entropy reflects the fact that the diversity of the input feature maps is directly related to that of the corresponding convolutional kernels. To determine the diversity of the kernels, a nearest neighbor distance matrix, A_{c}, is first computed for the c^{th} convolution kernel. A is defined as:

$${A}_{{C}_{i , j}} = \{ \begin{matrix}‖ {W}_{i , c} - {W}_{j , c} ‖ , & if {W}_{j , c} ∈ {\{ {W}_{i , c} \}}_{k} \\ 0 , & otherwise\end{matrix}$$

where {W_{i,c}}ₖ represents the k-nearest-neighbor of W_{i,c}. Then a density metric is calculated for W_{i,c}, which is defined as:

$$d m ( {W}_{i , c} ) = {\sum }_{j = 1}^{N} {A}_{{c}_{i , j}} ,$$

such that if dm(W) is large, then the convolutional kernel is more different from its neighbors, and vice versa. The kernel entropy is calculated as the entropy of the density metric:

$${e}_{c} = - {\sum }_{i = 1}^{N} \frac{d m ( {W}_{i , c} )}{{\sum }_{i = 1}^{N} d m ( {W}_{i , c} )} {log}_{2} \frac{d m ( {W}_{i , c} )}{{\sum }_{i = 1}^{N} d m ( {W}_{i , c} )}$$

A small e indicates diverse convolution kernels. Thus, the corresponding input feature map provides more information to the ConvNet. The overall KSE is defined as:

$$KSE = \sqrt{\frac{{s}_{c}}{1 + α {e}_{c}}} ,$$

where KSE, s_{c}, and e_{c} are normalized into [0, 1], and α is a parameter for controlling weight between s_{c} and e_{c}, which is set to 1 according to Exploiting kernel sparsity and entropy for interpretable cnn compression (referenced above).

As illustrated in FIG. 6B, KSE is first calculated for the input feature maps of layer i using the corresponding kernel weights from the i^{th} convolutional layer. The feature maps with KSE scores below a certain user-defined threshold, φ, are marked as meaningless. The indices of the convolution kernels that generate the “meaningless” feature maps from the (i−1)^{th} layer are then identified and recorded. The indices were used for creating a binary mask, M:

$${M}_{n} = \{ \begin{matrix}1 , if KSE ( {Y}_{n} ) < φ \\ 0 , if KSE ( {Y}_{n} ) \geq φ\end{matrix} ,$$

where φ is the user-defined KSE threshold. Mₙ zeros out the gradients for the “useful” kernels (i.e., KSE(Yₙ)≥φ), so that these kernels will not be modified during retraining. As shown in FIG. 6C, the back-propagation formula is then adjusted to incorporate Mₙ as:

$${W}_{n , c}^{( t + 1 )} = {W}_{n}^{( t )} - η \frac{\partial ℒ}{\partial {Y}_{n}^{( t )}} {M}_{n} {X}_{c}^{( t )} - \frac{\partial ℛ ( {W}_{n}^{( t )} )}{\partial {Y}_{n}^{( t )}} {M}_{n} {X}_{c}^{( t )}$$

Evaluation Metrics

For quantitative evaluation of the denoised v2 whole-body scans, the ensemble bias in the mean standard uptake value (SUV) of the simulated tumor that was inserted in a real patient background, and the liver coefficient of variation (CoV) were calculated from 10 noise realizations. The ensemble bias is formulated as:

$$BIAS ( \% ) = \frac{\frac{1}{R} {\sum }_{r}^{R} {μ}_{r}^{L} - {T}^{L}}{{T}^{L}} \times 100 ,$$

where μᵣ^{R} denotes the average counts within the lesion L of the r^{th} noise realization, and T^{L} represents the “true” (from high quality PET scan) intensity value within the lesion.

The liver CoV was computed as:

$$C o V ( \% ) = \frac{\frac{1}{N} {\sum }_{i ∈ B} {σ}_{j}^{R}}{{\overline{μ}}_{B}} \times 100$$

where σⱼ^{R} denotes the ensemble standard deviation of j^{th} voxel across R (R=10) realizations, N is the total number of voxels in the background volume-of-interest (VOI) B. The liver CoV is computed within a hand-drawn 3D VOI within the liver.

Comparison of the Training Time

The table below shows a comparison of data preparation and network training time used between the proposed method and training-from-scratch. “FT” denotes “fine-tuning”, and “Wk.” and “Pt.” stand for, respectively, “week” and “patient”. To form a complete dataset, it required approximately a week to reconstruct training pairs of noisy inputs and target for each patient (1 target+6 different count levels), and a total of 20 patients were used for training v1-net and v2-net.

| | | | | Percent |
|---|---|---|---|---|
| | | | | Time |
| Method | Img.Recon. | Network Training | Total Time | Saved |
| v1/v2-net | $1 \frac{wk}{PL} \times 20 Pts .$ | 5.5 days | 20.8 wks. | — |
| FT/TGS-net | $1 \frac{wk}{PL} \times 7 Pts .$ | 2.5 days | 7.4 wks. | 64% |

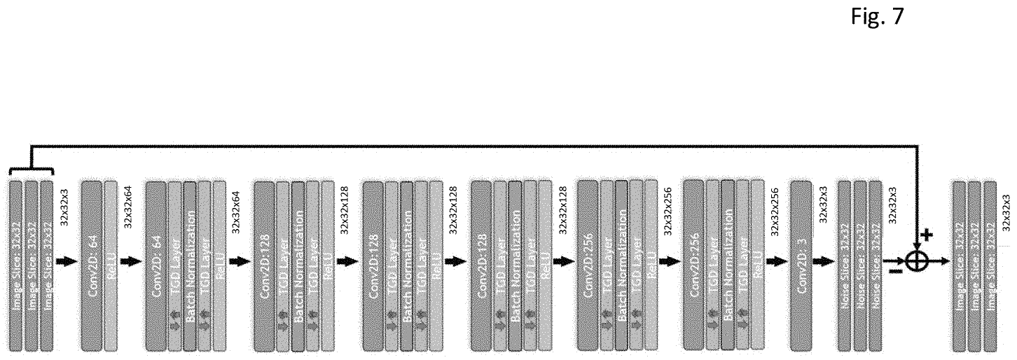

FIG. 7 is an illustration of a sample denoising network architecture of FIG. 6A supplemented to include first and second Targeted Gradient Descent (TGD) layers sandwiching the batch normalization layers in each of the hidden layers. The TGD layers are disabled during forward pass which means all kernels are activated. During back-propagation, the TGD layers are activated and only the update target kernels are updated. As shown in FIG. 7, at least one of the hidden layers that includes the respective first and second TGD layers also includes a rectified linear unit (ReLU) interposed between the second targeted gradient descent layer and a convolutional 2D layer of the input of the adjacent layer of the plurality of hidden layers.

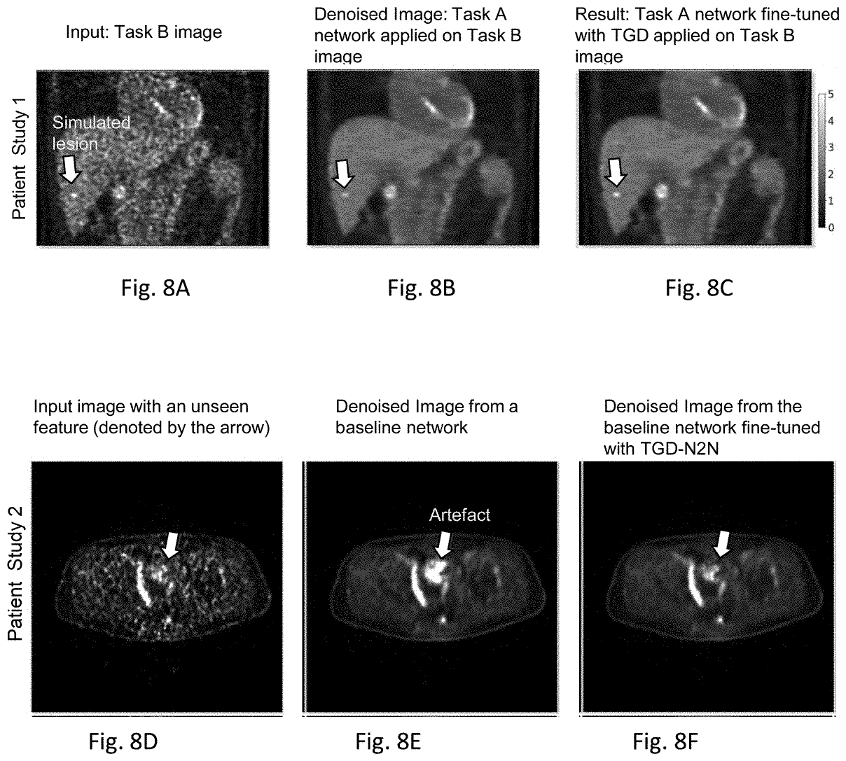

The effect of the re-training can be seen with respect to FIGS. 8A-8F. FIGS. 8A and 8D show new input images that were not part of the input images used to train a previously trained network 510. In FIG. 8A, the input image includes a simulated lesion, and in FIG. 8D, the input image includes an unseen feature. The resulting image of FIG. 8B after being applied to the previously trained network 510 reduces the visibility of the simulated lesion as compared with the image of FIG. 8C which was produced by a re-trained version of the previously trained network 510 that was fine-tuned with TGD processing on the Task B image. Similarly, the resulting image of FIG. 8E after being applied to the previously trained network 510 produces an artefact from the unseen feature whereas the image of FIG. 8F was produced by a re-trained version of the previously trained network 510 that was fine-tuned with TGD-Noise2Noise processing.

Advantageously, the modified neural network described herein can (1) extend a pre-trained network to a new task without revisiting data from a previous task or changing the network architecture, while achieving good performance on both tasks, (2) enable online learning (always learning) to avoid generating artefacts on out-of-distribution testing samples and optimize performance for each patient individually, and/or (3) be applied sequentially to fine-tune a network multiple times without performance degradation on prior tasks.

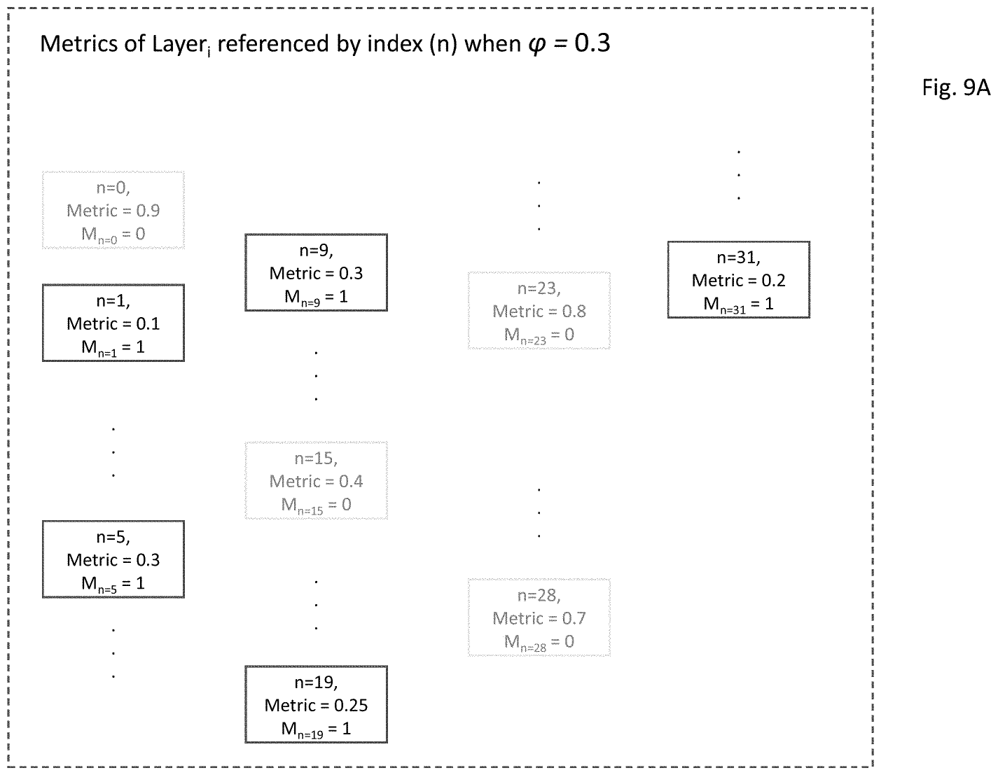

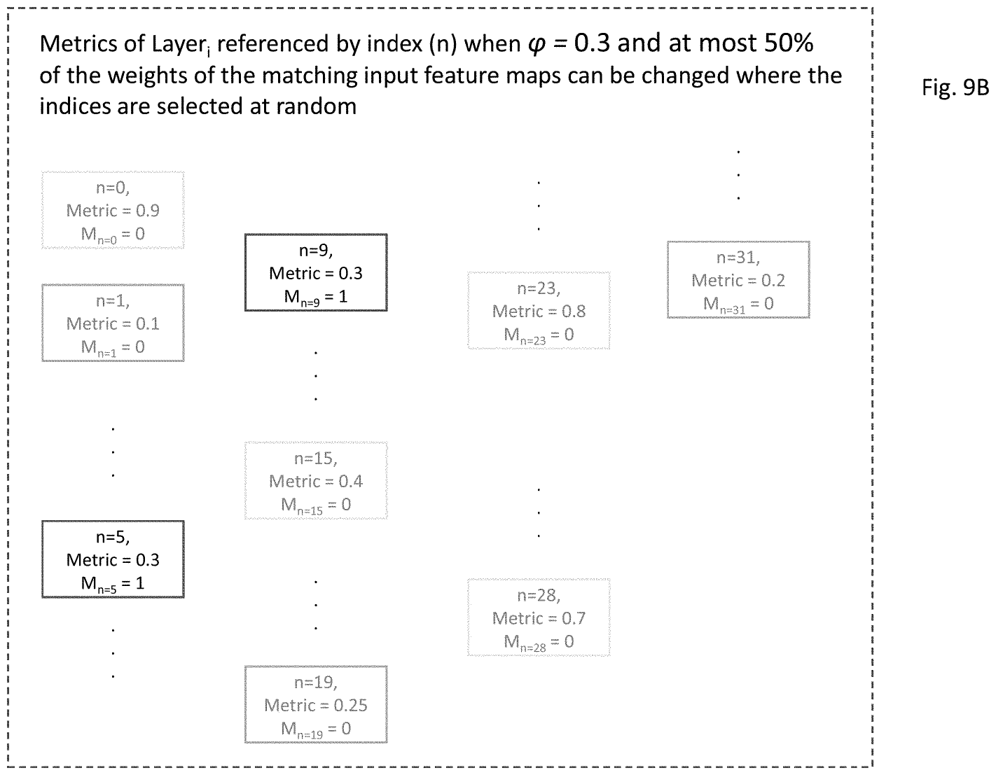

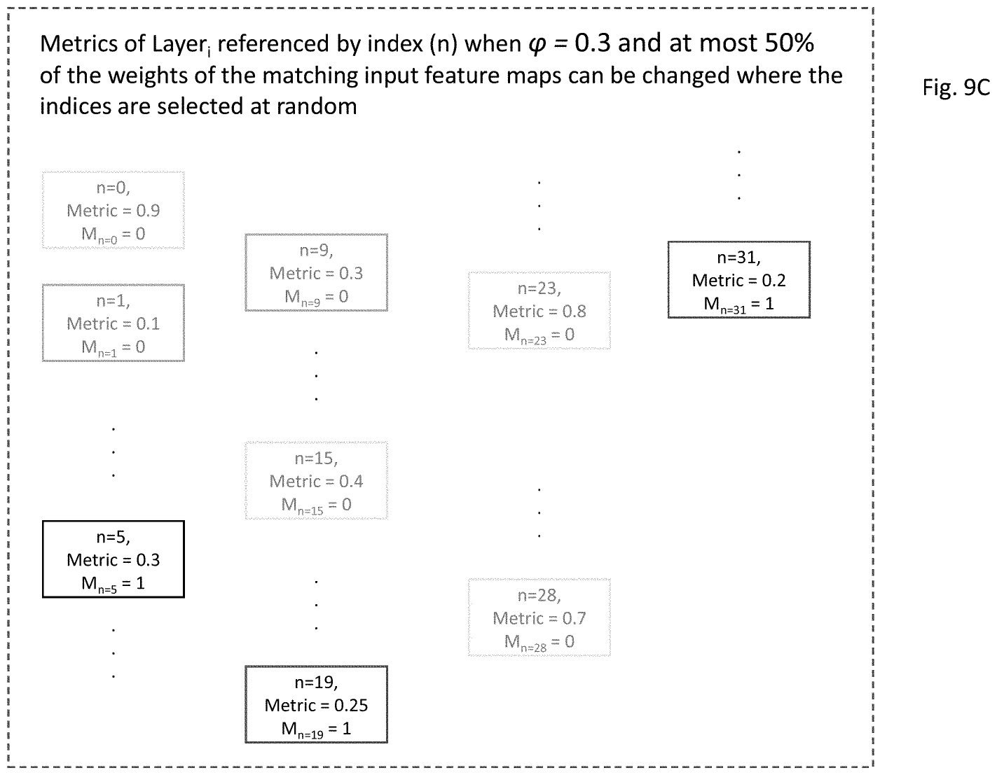

While the above-discussion has set the value of the mask Mₙ based on only the value of the metric as compared with the threshold, other criteria for setting the masks can be used. FIG. 9A illustrates the metric values calculated for the input feature maps of layer i using the corresponding weights from the i-th convolutional layer. Assuming that the usefulness threshold φ (which can also be referred to as ϕ) is chosen as 0.3, then the mask values Mₙ for layer i are shown therein when only the value of the metric as compared with the threshold is used. As shown in FIG. 9A, the input feature maps with mask values set to zero are “greyed out” to indicate that those input feature maps correspond to useful information that is not modified during the retraining process. For example, for illustrative purposes only, indices 1, 5, 9, 19, and 31 are classified as corresponding to “update target kernels” and the remaining indices are classified as “preserve target kernels.” A number of “preserve target kernels” (e.g., corresponding to indices 0, 15, 23, and 28) also are illustrated with their respective metrics to illustratively contrast with the “update target kernels.” (As would be apparent to those of skill in the art, the number of input feature maps of layer i is not limited to 32, and any number of input feature maps can be used.)

Various additional information can used to further refine what kernels are classified as update target kernels versus preserve target kernels (e.g., by setting mask values to 1 versus zero). For example, assuming that the usefulness threshold φ is chosen as 0.3 because higher threshold values have been determined to have unacceptable image degradation, the system may nonetheless not want to change all of the weights corresponding to input feature maps that are relatively useless. By using a more restrictive set of mask values, the system may “save” changing some of its more relatively useless input feature maps for later such that they can be changed to better learn a later-defined task. For example, when re-training an existing network trained for Task A to be refined to better address Task B, the system may “save” changing some of its more relatively useless input feature maps for later such that they can be changed to better learn Task C. As shown in FIGS. 9B and 9C, a second threshold, referred to herein as a MaximumChange threshold, may set the maximum percentage (or number) of input feature maps that can be used in a single retraining process. As shown therein, although 5 input features maps can be changed if just the usefulness threshold φ is used, by limiting the MaximumChange threshold to 50%, only 2 or three illustrated input feature maps are changed. Because the indices are chosen at random, FIGS. 9B and 9C can have different mask values set to 1. The MaximumChange threshold need not be 50% and indeed may be based on an absolute number or a number relative to the number of expected retrainings (e.g., ½ for 2 expected retrainings, ⅓ for three expected retrainings, . . . 1/n for n expected retrainings).

Alternatively, other parameters can be used to restrict which indices correspond to mask values indicating needed/desired retraining. Instead of choosing randomly, within the MaximumChange threshold of the metric values less than or equal to 0.3 (i.e., 0.1, 0.2, 0.25, 0.3, and 0.3), the indices to be retrained can be chosen uniformly across the scale of possible values (i.e., 0.1, 0.25, and 0.3). Similarly, instead of choosing randomly, within the MaximumChange threshold of the metric values less than or equal to 0.3 (i.e., 0.1, 0.2, 0.25, 0.3, and 0.3), the indices to be retrained can be chosen from smallest to largest across the scale of possible values (i.e., 0.1, 0.2, and 0.25) or largest to smallest (i.e., 0.3, 0.3, and 0.25). In addition, although a fixed threshold of 0.3 has been described herein, that threshold is merely exemplary and other thresholds are possible. For example, the threshold can be varied until a noise resulting from the new network is a particular percentage of the original network (e.g., the new neural network creates 10% error compared to the original network). In other applications (such as CT or MR denoising), other criteria may also be used, such as the preservation of lesion/feature contrast, when the background noise distribution is more uniform and the noise magnitude is relatively lower.

In configurations such as those described above where not all of the kernels that could be updated are actually updated, the system may track the kernels that could have been updated but were not such that those may be selected directly for updating in a future training process, regardless of their metric compared to other kernels (such as, but not limited to, the kernels updated in an earlier re-training). For example, in the random selection of indices 5 and 9 of FIG. 9B during a first classification for a first re-training, indices 1, 19, and 31 may be stored in a list of indices to be used in a second classification for a second re-training. Thus, the system may cause certain kernels to be more focused on a particular new task.

In yet another configuration, a neural network that is initially being trained may be configured with kernels and/or layers of kernels that initially are prevented from being trained with useful information so that the initially trained network is ensured to have relatively useless kernels that can be used in re-training later. For example, after configuring and training an initial network using a series of images such that the initially trained network meets the processing goals for Task A (e.g., denoising a particular type of image), the number of kernels and layers in the initially trained network may be increased in a new network that has an increased number of kernels and/or layers to ensure that the new network will have more kernels than needed (e.g., 5% to 15% more kernels or 1 or two more layers), and the new network is then retrained using the same images so that the new network has relatively useless kernels to be replaced in future trainings.

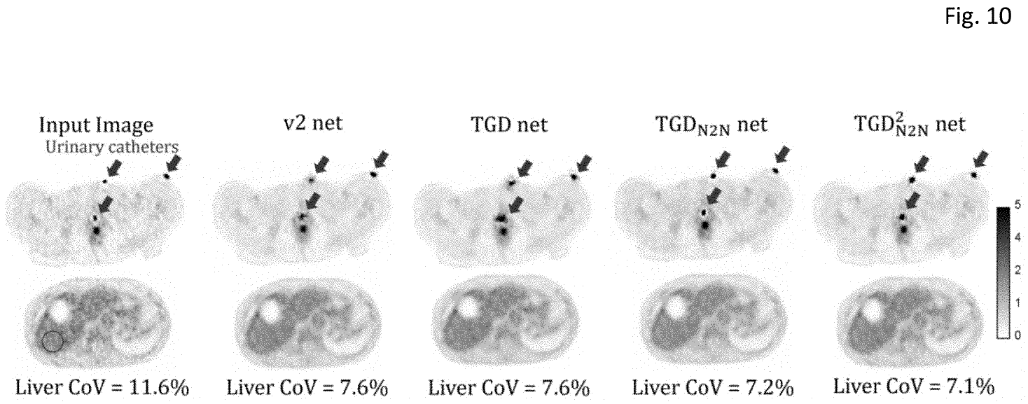

FIG. 10 is a set of comparison images comparing an embodiment of the present invention with other methods on a FDG-PET patient study which had urinary catheters attached during the scan (denoted by the arrows). The first and second rows show the trans-axial slices of the urinary catheters and liver of the same study, respectively. All the images are displayed in the same inverted grey scale. This study was acquired for 120-sec, which was rebinned into 2 noise samples with equal count levels (60-sec) for the TGD-N2N training. Both TGD-N2N networks were retrained for 150 epochs. All the networks were then applied to the 120-sec scan (input image) to generate the denoised results. The out-of-distribution objects (catheters) led to artifacts in both v2-net and TGD-net results. The online learning approaches using TGDN2N-net (with φ=0:36) and TGD2 N2N-net (with φ=0:3; 0:4) alleviated the artifacts while retaining similar denoising performance in terms of liver Coefficient-of-Variations (CoV) in the ROI denoted by the red circle. The KSE threshold for both TGD-N2N results were adjusted to achieve similar liver CoV.

Targeted Gradient Descent (TGD) in PET Denoising

An embodiment of the TGD method described herein is applied to the task of PET image denoising in two applications. First, TGD is used to fine-tune an existing denoising ConvNet to make it adapt to a new reconstruction protocol using substantially fewer training studies. Second, TGD is used in an online-learning approach to avoid the ConvNet generating artifacts (hallucinations) on unseen features during testing.

TGD Fine Tuning

In the first application, a network was trained using FDG PET images acquired on a commercial SiPM PET/CT scanner reconstructed from a prior version of the ordered subset expectation maximization (OSEM) algorithm. For simplicity, these images are denoted as the v1 images and the denoising ConvNet trained using these images as the v1 network.

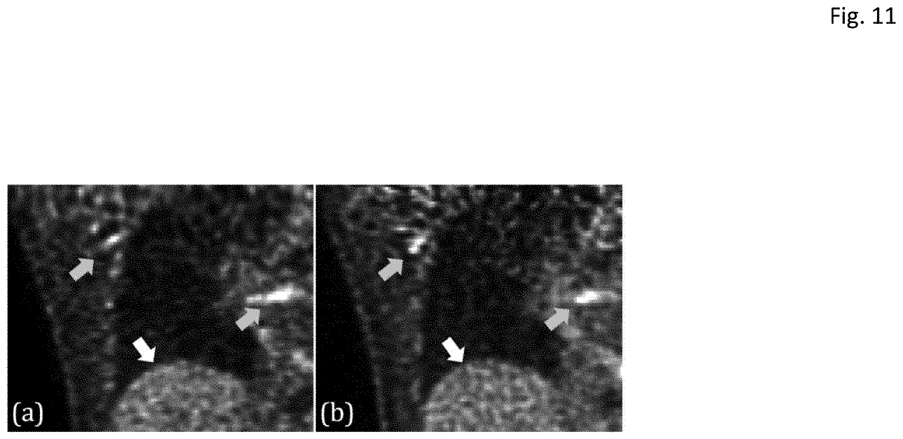

The PET images reconstructed by an updated OSEM algorithm are denoted as the v2 images and the corresponding denoising ConvNet as the v2 network. The system resolution modeling and scatter estimation in v2 reconstruction were optimized over the v1 reconstruction. Therefore, the noise texture in v2 images is finer, indicating a smaller correlation among neighboring pixels as shown in FIG. 11. The application of the v1 network on v2 images produced over-smoothed results and suppressed activity in small lesions, which could potentially lead to misdiagnosis. In general, FIG. 11 shows PET images of the right lung of a human subject reconstructed with (a) v1 reconstruction and (b) v2 reconstruction methods, respectively. The arrows pointing from lower left to upper right point to structures that become elongated in v1 images due to the sub-optimal resolution modeling, which are corrected in the v2 reconstruction. The optimized resolution modeling also produced the liver noise texture (denoted by the arrows pointing from upper left to lower right) with a finer grain size (which represents a small correlation between neighboring pixels) in the (b) than (a).

Conventionally, whenever the reconstruction algorithm is updated, the entire training datasets have to be re-reconstructed, and the denoising network has to be retrained using the updated images for optimal performance, followed by qualitative and quantitative assessments on a cohort of testing studies. This process is extremely tedious and time-consuming.

The v1 network was trained using 20×v1 whole-body FDG-PET human studies with a mixture of low (<23) and high BMI (>28). These studies were acquired for 10-min/bed, which were used as the target images. The list mode data was uniformly subsampled into 6 noise levels as 30, 45, 60, 90, 120, 180 sec/bed as the noisy inputs for noise adaptive training as described in Chan, C., Zhou, J., Yang, L., Qi, W., Kolthammer, J., Asma, E.: Noise adaptive deep convolutional neural network for whole-body pet denoising. In: 2018 IEEE Nuclear Science Symposium and Medical Imaging Conference Proceedings (NSS/MIC). pp. 1-4. IEEE (2018), incorporated herein by reference. All these studies consist of 30,720 training slices in total.

This v1 network was adapted using the TGD method to denoising v2 PET images. During the TGD's retraining stage, only 7 training datasets were used that consisted of PET scans from patients with low BMI (<23). However, the retrained network retained the knowledge on how to denoise PET scans of high BMI patients learned from the previous task (images of high BMI subjects are commonly substantially noisier than those of low BMI subjects). It is important to emphasize that the amount of v1 images used in v1 network training was significantly more than the amount of v2 images used in TGD fine-tuning. Based on this fact, the weights of the noise classifier layer (i.e., the last convolutional layer) in the TGD-net were kept unchanged during the retraining, thus avoiding the last layer from being biased by the v2 image data.

Online Learning

In the second experiment, TGD was shown to enable online-learning that further optimize the network's performance on each testing study and prevents artifacts (hallucination) from occurring on out-of-distribution features. This is achieved by using TGD with Noise-2-Noise (N2N) training scheme such as is described in (1) Chan, C., Zhou, J., Yang, L., Qi, W., Asma, E.: Noise to noise ensemble learning for pet image denoising. In: 2019 IEEE Nuclear Science Symposium and Medical Imaging Conference (NSS/MIC). pp. 1-3. IEEE (2019) and (2) Lehtinen, J., Munkberg, J., Hasselgren, J., Laine, S., Karras, T., Aittala, M., Aila, T.: Noise2noise: Learning image restoration without clean data. In: ICML (2018), both of which are incorporated herein by reference. Specifically, testing study list-mode data acquired with 120-sec was rebinned into 2 noise realizations with equal count levels (60-sec). A TGD method was used to fine-tune the denoising network by using noise samples 1 and 2 as the inputs and noise samples 2 and 1 as the targets. The online-learning network is denoted as TGD_{N2N}-net. To a greater extent, this procedure was also applied to the TGD-net from the first experiment (the network was TGD fine-tuned twice), and the resulting network is denoted as TGD_{N2N}²-net for convenience.

### Additional Experimental Results

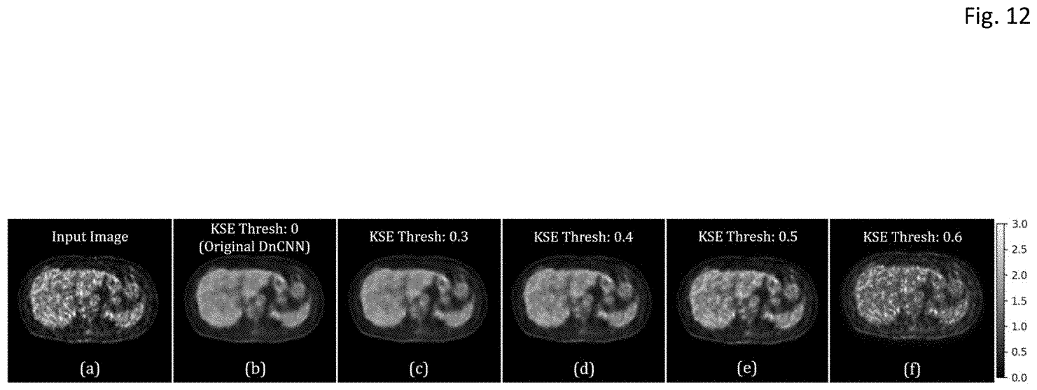

It is possible to select a KSE threshold experimentally. In one experiment, the kernels identified as “meaningless” were varied to examine whether these kernels indeed contributed less to the network. FIG. 12 shows the results of several variations, where (a) shows an example slice of a PET scan, and (b) shows the denoised PET image from the v1 DnCNN (this can be interpreted as having a KSE threshold=0, because no kernel was dropped). Four thresholds (0.3, 0.4, 0.5, and 0.6) were then selected arbitrarily such that the larger the threshold, the more the kernels were dropped. The percentage of the parameters that were dropped using the four thresholds are, respectively, 51.4%, 51.6%. 53.0%, and 67.3%, and the corresponding denoised results are shown in (c), (d), (e), and (f) of FIG. 12, respectively. The result from φ=0:3 is almost identical to the original DnCNN's result. Whereas, when φ>0:4, some severe artifacts begin to occur in the resulting images. Therefore, the usefulness threshold or KSE threshold, p, was set to be 0.3 during the analysis described below. However, those of skill in the art should understand that other usefulness threshold may be appropriate for other domains, and the usefulness threshold may even change between retraining processes.

A TGD-net was compared to several baseline methods, including: (1) v1-net: A DnCNN trained using 20×v1 PET images; (2) v2-net: A DnCNN trained using the same 20 studies but reconstructed with v2 algorithm; (3) FT-net: Fine-tuning the last three convolutional blocks of v1-net using only 7×v2 images; (4) TGD-net: v1-net fine-tuned using the TGD layers with 7×v2 images (same studies as used in the FT-net). All networks were trained with 500 epochs.

The TGD_{N2N}²-net^{φ=0:3;0:4} and TGD_{N2N}-net^{φ=0:4} were built based on the previous TGD-net and v2-net, respectively. These networks were retrained using two noise realizations from a single study (i.e., N2N training). They were compared to: (1) v2-net (same as above); and (2) TGD-net^{φ=0:3} (the TGD-net obtained from the previous task). The TGD_{N2N} models were trained with 150 epochs.

Exemplary methods were compared in terms of denoising on a number of FDG patient studies reconstructed with v2 algorithm (v2 images). A first study was acquired with 600-sec/bed with a simulated tumor that was simulated to be inserted in the liver. The list-mode study was rebinned into 10×60-sec/bed image independent identically distributed (i.i.d.) noise realizations to assess the ensemble bias on the tumor and liver coefficient of variation (CoV) by using the 600-sec/bed image as the ground truth. A second 60-sec/bed study was also used.

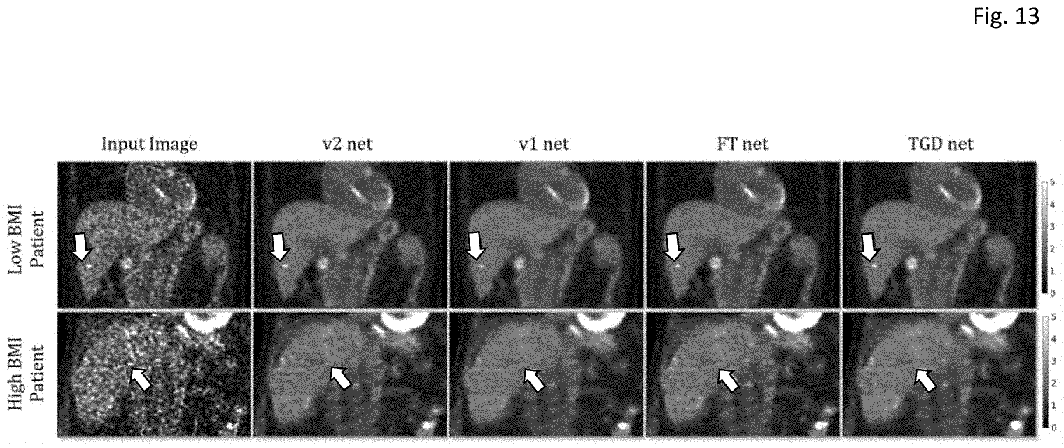

In addition, FIG. 13 shows the denoised results of the example cropped slices of the v2 PET images, where the figures in the first column represent the input image. Qualitatively, v1-net (the third column of FIG. 13) over-smoothed the v2 image that led to piece-wise smoothness in the liver and reduced uptake in the synthetic lesion compared to the results from other methods. In contrast, the result from v2-net (the second column) exhibited a higher lesion contrast with more natural noise texture (fine grain size) in liver regions. The fine-tuned networks (FT-net) yielded good performances on denoising the low-BMI patient PET scans (the top figure of the fourth column) with higher lesion contrast. However, the speckle noise (denoted by the lower-right to upper left arrows) in the high-BMI-patient PET scans was also preserved. Thus, the TGD-net yielded good lesion contrast but also low variations in the liver for both low- and high-BMI patient scans. Quantitative evaluations are shown in Table 1 below where the table shows ensemble bias and CoV comparison results of the different training methods on the PET scan of the low-BMI patient.

TABLE 1

| | v1-net | v2-net | FT-net | TGD-net^{0.3} |
|---|---|---|---|---|
| Lesion Bias (%) | −6.30 | −4.07 | −4.71 | −3.77 |
| Liver CoV (%) | 6.02 | 8.56 | 7.87 | 6.46 |

The best performance (−3.77) is provided by the TGD-net^{0.3}. For the low-BMI patient study, the selected method (φ=0:3) achieved the best lesion quantification with a small ensemble bias of −3.77% while maintaining a low-noise level of 6.45% in terms of CoV. In addition, fine-tuning a TGD net from the v1-net saved 64% of computational time compared to the training-from-scratch v2-net.

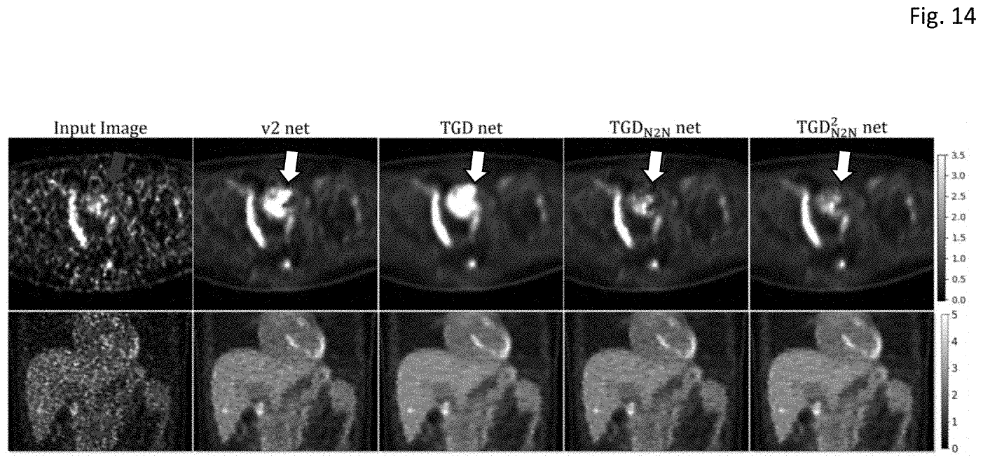

FIG. 14 shows denoised results of the example cropped slices of the v2 PET images. Prior to TGD-N2N training, v2-net and TGD-net created artifactual features (hallucination) around the bladder region (denoted by the arrows). In contrast, the networks fine-tuned using the TGD-N2N online learning scheme did not produce any artifacts, where the bladder's shape is nearly the same as that of the input image. To a greater extend, TGD_{N2N}²-net^{φ=0:3;0:4} and TGD_{N2N}-net^{φ=0:4} retained the denoising performances of their base networks (i.e., v2-net and TGD-net).

In the preceding description, specific details have been set forth, such as a particular method and system for improving medical image quality through the use of neural networks. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Embodiments of the present disclosure may also be as set forth in the following parentheticals.

(1) A training apparatus for a convolutional neural network (CNN) for medical data, the training apparatus including, but not limited to: processing circuitry configured to: (a) receive a trained CNN based on medical data set for first task, (b) calculate a first set of usefulness scores on a plurality of kernels included in hidden layers of the trained CNN, (c) classify each of the plurality of kernels into an update target kernel and preserve target kernel, based on the calculated first set of usefulness scores and a first threshold, and (d) perform a re-training process based on inputting of medical data set for a second task, wherein the re-training process is configured to (1) preserve a first set of kernels of the plurality of kernels classified as preserve target kernels and (2) update a second set of kernels of the plurality of kernels classified as update target kernels.

(2) The training apparatus of (1), wherein the processing circuitry configured to calculate the first set of usefulness scores on the plurality of kernels included in the hidden layers of the trained CNN includes, but is not limited to, processing circuitry configured to calculate the first set of usefulness scores based on a magnitude-based kernel ranking.

(3) The training apparatus of (1) or (2), wherein the processing circuitry configured to calculate the first set of usefulness scores on the plurality of kernels included in the hidden layers of the trained CNN comprises processing circuitry configured to calculate the first set of usefulness scores based on a Kernel Sparsity and Entropy (KSE) metric.

(4) The training apparatus of any of (1) to (3), wherein the processing circuitry configured to perform the re-training process includes, but is not limited to, processing circuitry configured to perform a re-training process based on inputting of noise-to-noise medical data.

(5) The training apparatus of any of (1) to (4), further including, but not limited to, processing circuitry configured to: (e) calculate a second set of usefulness scores on the plurality of kernels included in the hidden layers of the trained CNN, (f) classify each of the plurality of kernels into an update target kernel and preserve target kernel, based on the calculated second set of usefulness scores and a second threshold, and (g) perform a second re-training process based on inputting of medical data set for a third task, wherein the second re-training process is configured to, based on the calculated second set of usefulness scores and the second threshold, (1) preserve a second set of kernels of the plurality of kernels classified as preserve target kernels and (2) update a second set of kernels of the plurality of kernels classified as update target kernels.

(6) The training apparatus of (5), wherein the first and second thresholds are different.

(7) The training apparatus of (5), wherein the first threshold equals the second threshold.

(8) The training apparatus of any of (1) to (7) as claimed in claim 1, wherein the processing circuitry configured classify each of the plurality of kernels into an update target kernel and preserve target kernel, based on the calculated first set of usefulness scores and a first threshold includes, but is not limited to, processing circuitry configured to classify each of the plurality of kernels into an update target kernel and preserve target kernel, based on (1) the calculated first set of usefulness scores, (2) the first threshold, and a maximum number of kernels to be classified as update target kernels in a single re-training process.

(9) The training apparatus of any of (1) to (8), wherein the first threshold is selected based on an amount of image degradation caused by re-training using update target kernels classified using a value that updates more target kernels than the first threshold.

(10) The training apparatus of any of (1) to (9), wherein the maximum number of kernels to be classified as update target kernels in a single re-training process are selected randomly.

(11) The training apparatus of any of (1) to (10), wherein the maximum number of kernels to be classified as update target kernels in a single re-training process are selected uniformly based on the calculated first set of usefulness scores.

(12) The training apparatus of any of (1) to (11), wherein the medical data comprises computed tomography (CT) data.

(13) The training apparatus of any of (1) to (12), wherein the medical data comprises positron emission tomography (PET) data.

(14) In a neural network including an input layer, an output layer, and a plurality of hidden layers including a set of hidden layers each including a convolutional 2D layer and a batch normalization layer, the improvement, in the set of hidden layers each including the convolutional 2D layer and the batch normalization layer, includes, but is not limited to: (a) a first targeted gradient descent layer interposed between the convolutional 2D layer and the batch normalization layer; and (b) a second targeted gradient descent layer interposed between the batch normalization layer and a convolutional 2D layer of an input of an adjacent layer of the plurality of hidden layers.

(15) In the improved neural network of (14), wherein in the set of hidden layers each including the convolutional 2D layer and the batch normalization layer, the improvement further including, but not limited to, a rectified linear unit interposed between the second targeted gradient descent layer and the convolutional 2D layer of the input of the adjacent layer of the plurality of hidden layers.

(16) A neural network, having an input layer and output layer, for processing medical data, the neural network including, but is not limited to: processing circuitry configured to implement a plurality of hidden layers including a set of hidden layers each including, but not limited to: (a) a convolutional 2D layer, (b) a batch normalization layer, (c) a first targeted gradient descent layer interposed between the convolutional 2D layer and the batch normalization layer; and (d) a second targeted gradient descent layer interposed between the batch normalization layer and a convolutional 2D layer of an input of an adjacent layer of the plurality of hidden layers.

(17) The neural network of (16), further including, but is not limited to, processing circuitry configured to: (a) calculate a first set of usefulness scores on a plurality of kernels included in the set of hidden layers, wherein the plurality of kernels are trained for performing a first task; (b) classify each of the plurality of kernels into an update target kernel and preserve target kernel, based on the calculated first set of usefulness scores and a first threshold, and (c) perform a re-training process based on inputting of medical data set for a second task other than the first task, wherein the re-training process is configured to (1) preserve a first set of kernels of the plurality of kernels classified as preserve target kernels and (2) update a second set of kernels of the plurality of kernels classified as update target kernels.

(18) The neural network of (16) or (17), wherein in the set of hidden layers, at least one hidden layer further comprises a rectified linear unit interposed between the second targeted gradient descent layer and the convolutional 2D layer of the input of the adjacent layer of the plurality of hidden layers.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the claims.

1. A training apparatus for a convolutional neural network (CNN) for medical data, the training apparatus comprising:
processing circuitry configured to:
receive a trained CNN based on medical data set for first task,
calculate a first set of usefulness scores on a plurality of kernels included in hidden layers of the trained CNN,
classify each of the plurality of kernels into an update target kernel and preserve target kernel, based on the calculated first set of usefulness scores and a first threshold, and
perform a re-training process based on inputting of medical data set for a second task, wherein the re-training process is configured to (1) preserve a first set of kernels of the plurality of kernels classified as preserve target kernels and (2) update a second set of kernels of the plurality of kernels classified as update target kernels.

2. The training apparatus as claimed in claim 1, wherein the processing circuitry configured to calculate the first set of usefulness scores on the plurality of kernels included in the hidden layers of the trained CNN comprises processing circuitry configured to calculate the first set of usefulness scores based on a magnitude-based kernel ranking.

3. The training apparatus as claimed in claim 1, wherein the processing circuitry configured to calculate the first set of usefulness scores on the plurality of kernels included in the hidden layers of the trained CNN comprises processing circuitry configured to calculate the first set of usefulness scores based on a Kernel Sparsity and Entropy (KSE) metric.

4. The training apparatus as claimed in claim 1, wherein the processing circuitry configured to perform the re-training process comprises processing circuitry configured to perform a re-training process based on inputting of noise-to-noise medical data.

5. The training apparatus as claimed in claim 1, further comprising processing circuitry configured to:
calculate a second set of usefulness scores on the plurality of kernels included in the hidden layers of the trained CNN,
classify each of the plurality of kernels into an update target kernel and preserve target kernel, based on the calculated second set of usefulness scores and a second threshold, and
perform a second re-training process based on inputting of medical data set for a third task, wherein the second re-training process is configured to, based on the calculated second set of usefulness scores and the second threshold, (1) preserve a second set of kernels of the plurality of kernels classified as preserve target kernels and (2) update a second set of kernels of the plurality of kernels classified as update target kernels.

6. The training apparatus as claimed in claim 5, wherein the first and second thresholds are different.

7. The training apparatus as claimed in claim 5, wherein the first threshold equals the second threshold.

8. The training apparatus as claimed in claim 1, wherein the processing circuitry configured classify each of the plurality of kernels into an update target kernel and preserve target kernel, based on the calculated first set of usefulness scores and a first threshold comprises processing circuitry configured to classify each of the plurality of kernels into an update target kernel and preserve target kernel, based on (1) the calculated first set of usefulness scores, (2) the first threshold, and a maximum number of kernels to be classified as update target kernels in a single re-training process.

9. The training apparatus as claimed in claim 1, wherein the first threshold is selected based on an amount of image degradation caused by re-training using update target kernels classified using a value that updates more target kernels than the first threshold.

10. The training apparatus as claimed in claim 1, wherein the maximum number of kernels to be classified as update target kernels in a single re-training process are selected randomly.

11. The training apparatus as claimed in claim 1, wherein the maximum number of kernels to be classified as update target kernels in a single re-training process are selected uniformly based on the calculated first set of usefulness scores.

12. The training apparatus as claimed in claim 1, wherein the medical data comprises computed tomography (CT) data.

13. The training apparatus as claimed in claim 1, wherein the medical data comprises positron emission tomography (PET) data.

14. In a neural network including an input layer, an output layer, and a plurality of hidden layers including a set of hidden layers each including a convolutional 2D layer and a batch normalization layer, the improvement, in the set of hidden layers each including the convolutional 2D layer and the batch normalization layer, comprising:
a first targeted gradient descent layer interposed between the convolutional 2D layer and the batch normalization layer; and
a second targeted gradient descent layer interposed between the batch normalization layer and a convolutional 2D layer of an input of an adjacent layer of the plurality of hidden layers.

15. In the improved neural network as claimed in claim 14, wherein in the set of hidden layers each including the convolutional 2D layer and the batch normalization layer, the improvement further comprising a rectified linear unit interposed between the second targeted gradient descent layer and the convolutional 2D layer of the input of the adjacent layer of the plurality of hidden layers.

16. A neural network, having an input layer and output layer, for processing medical data, the neural network comprising:
processing circuitry configured to implement a plurality of hidden layers including a set of hidden layers each including:
a convolutional 2D layer,
a batch normalization layer,
a first targeted gradient descent layer interposed between the convolutional 2D layer and the batch normalization layer; and
a second targeted gradient descent layer interposed between the batch normalization layer and a convolutional 2D layer of an input of an adjacent layer of the plurality of hidden layers.

17. The neural network as claimed in claim 16, further comprising processing circuitry configured to:
calculate a first set of usefulness scores on a plurality of kernels included in the set of hidden layers, wherein the plurality of kernels are trained for performing a first task;
classify each of the plurality of kernels into an update target kernel and preserve target kernel, based on the calculated first set of usefulness scores and a first threshold, and
perform a re-training process based on inputting of medical data set for a second task other than the first task, wherein the re-training process is configured to (1) preserve a first set of kernels of the plurality of kernels classified as preserve target kernels and (2) update a second set of kernels of the plurality of kernels classified as update target kernels.

18. The neural network as claimed in claim 16, wherein in the set of hidden layers, at least one hidden layer further comprises a rectified linear unit interposed between the second targeted gradient descent layer and the convolutional 2D layer of the input of the adjacent layer of the plurality of hidden layers.
